(19) United States
(12) Patent Application Publication
(10) Pub. No.: US 2025/0035127 A1
(43) Pub. Date: Jan. 30, 2025

(54) TURBINE AND TURBOCHARGER

(71) Applicant: IHI CORPORATION, Tokyo (JP)

(72) Inventors: Kengo IKEDA, Tokyo (JP); Takao ASAKAWA, Tokyo (JP); Ryosuke MIYAO, Tokyo (JP); Seiya NAKAZAWA, Tokyo (JP)

(73) Assignee: IHI CORPORATION, Tokyo (JP)

(21) Appl. No.: 18/917,547

(22) Filed: Oct. 16, 2024

Related U.S. Application Data
(63) Continuation of application No. PCT/JP2023/001388, filed on Jan. 18, 2023.

(30) Foreign Application Priority Data
May 25, 2022 (JP) 2022-085554

(51) Int. Cl. F04D 29/42; F04D 17/10; F04D 29/58

(52) U.S. Cl. CPC F04D 29/4206; F04D 17/10; F04D 29/5853

(57) ABSTRACT

Provided is a turbine including: a housing including: an accommodating space that accommodates a turbine impeller; a turbine scroll flow passage arranged on a radially outer side with respect to the turbine impeller; a communicating flow passage that allows communication between the turbine scroll flow passage and the accommodating space; and a discharge flow passage continuous with the accommodating space in a rotation axis direction of the turbine impeller; a vane member that includes a plurality of vane portions opposed to a first inner wall portion facing the communicating flow passage from a side opposite to the discharge flow passage, and is provided in the communicating flow passage; and an elastic member sandwiched by a second inner wall portion facing the communicating flow passage from the discharge flow passage side, and the vane member.

### CROSS REFERENCE TO RELATED APPLICATIONS

This application is a continuation application of International Application No. PCT/JP2023/001388, filed on Jan. 18, 2023, which claims priority to Japanese Patent Application No. 2022-085554, filed on May 25, 2022, the entire contents of which are incorporated by reference herein.

### BACKGROUND ART

### Technical Field

The present disclosure relates to a turbine and a turbocharger. This application claims the benefit of priority to Japanese Patent Application No. 2022-085554 filed on May 25, 2022, and contents thereof are incorporated herein.

### Related Art

In a turbine provided in a turbocharger or the like, an accommodating space that accommodates a turbine impeller is provided. For example, as disclosed in Patent Literature 1, a vane member may be provided in a communicating flow passage that allows communication between the accommodating space and a turbine scroll flow passage. The vane member includes a plurality of vane portions arranged at intervals in a circumferential direction of the turbine impeller. A flow rate of exhaust gas flowing into the accommodating space of the turbine impeller is adjusted by the plurality of vane portions.

### CITATION LIST

### Patent Literature

Patent Literature 1: JP 2009-144664 A

### SUMMARY

### Technical Problem

As the vane member, the vane portions may be of a fixed type rather than a movable type. In the vane member with the vane portions of a fixed type, the vane portions are biased to be pressed against an inner wall portion of a housing of the turbine. When each member of the turbine is thermally deformed, a clearance may be generated between the vane portions and the inner wall portion of the housing. As a result, the flow of the exhaust gas flowing into the accommodating space of the turbine impeller is disturbed, and there is a fear in that the efficiency of the turbine decreases.

An object of the present disclosure is to provide a turbine and a turbocharger capable of suppressing a decrease in efficiency of the turbine.

### Solution to Problem

In order to solve the above-mentioned problem, according to the present disclosure, there is provided a turbine including: a housing including: an accommodating space that accommodates a turbine impeller; a turbine scroll flow passage arranged on a radially outer side with respect to the turbine impeller; a communicating flow passage that allows communication between the turbine scroll flow passage and the accommodating space; and a discharge flow passage continuous with the accommodating space in a rotation axis direction of the turbine impeller; a vane member that includes a plurality of vane portions opposed to a first inner wall portion facing the communicating flow passage from a side opposite to the discharge flow passage, and is provided in the communicating flow passage; and an elastic member sandwiched by a second inner wall portion facing the communicating flow passage from the discharge flow passage side, and the vane member.

The vane member may include a base portion held in abutment against the elastic member, and a seal member may be provided between the base portion and the housing.

The turbine may further include a heat-shielding plate including the first inner wall portion.

The elastic member may be a disc spring.

In order to solve the above-mentioned problem, according to the present disclosure, a turbocharger includes the above-mentioned turbine.

### Effects

According to the present disclosure, it is possible to suppress a decrease in efficiency of the turbine.

### BRIEF DESCRIPTION OF DRAWINGS

FIG. 1 is a schematic sectional view for illustrating a turbocharger of an embodiment of the present disclosure.

FIG. 2 is a sectional view taken along the line A-A in

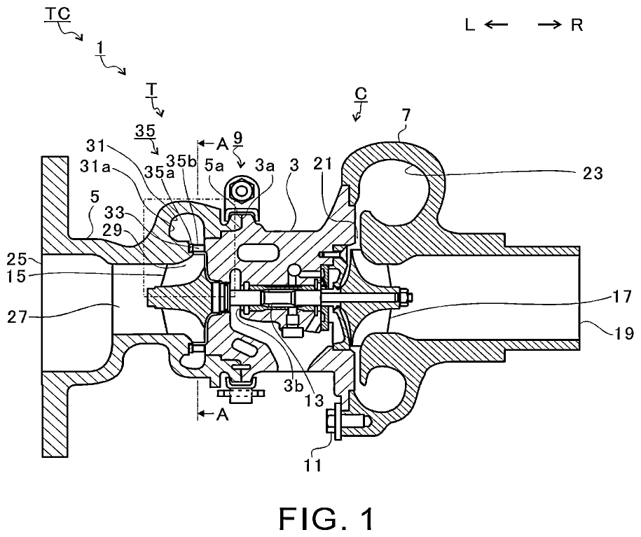

FIG. 1.

FIG. 3 is a partially enlarged view for illustrating a turbine of the embodiment of the present disclosure.

FIG. 4 is a partially enlarged view for illustrating a turbine of a first modification example.

FIG. 5 is a partially enlarged view for illustrating a turbine of a second modification example.

### DESCRIPTION OF EMBODIMENTS

Now, with reference to the attached drawings, one embodiment of the present disclosure is described. The dimensions, materials, and other specific numerical values represented in the embodiment are merely examples used for facilitating the understanding of the disclosure, and do not limit the present disclosure unless otherwise particularly noted. Elements having substantially the same functions and configurations herein and in the drawings are denoted by the same reference symbols to omit redundant description thereof. Further, illustration of elements with no direct relationship to the present disclosure is omitted.

FIG. 1 is a schematic sectional view for illustrating a turbocharger TC. In the following, description is given while a direction indicated by the arrow L illustrated in FIG. 1 corresponds to a left side of the turbocharger TC. A direction indicated by the arrow R illustrated in FIG. 1 corresponds to a right side of the turbocharger TC. As illustrated in FIG. 1, the turbocharger TC includes a turbocharger main body 1. The turbocharger main body 1 includes a bearing housing 3, a turbine housing 5, and a compressor housing 7. The turbine housing 5 is coupled to a left side of the bearing housing 3 by a fastening mechanism 9. The compressor housing 7 is coupled to a right side of the bearing housing 3 by a fastening bolt 11.

The turbocharger TC includes a turbine T and a centrifugal compressor C. The turbine T includes the bearing housing 3 and the turbine housing 5. That is, the bearing housing 3 and the turbine housing 5 correspond to a housing of the turbine T. The centrifugal compressor C includes the bearing housing 3 and the compressor housing 7. That is, the bearing housing 3 and the compressor housing 7 correspond to a housing of the centrifugal compressor C.

A protrusion 3a is formed on an outer peripheral surface of the bearing housing 3. The protrusion 3a is formed on the turbine housing 5 side. The protrusion 3a protrudes in a radial direction of the bearing housing 3. A protrusion 5a is formed on an outer peripheral surface of the turbine housing 5. The protrusion 5a is formed on the bearing housing 3 side. The protrusion 5a protrudes in a radial direction of the turbine housing 5. The bearing housing 3 and the turbine housing 5 are band-fastened by the fastening mechanism 9. The fastening mechanism 9 is, for example, a G coupling. The fastening mechanism 9 clamps the protrusion 3a and the protrusion 5a.

The bearing housing 3 has a bearing hole 3b formed therein. The bearing hole 3b passes through the bearing housing 3 in a right-and-left direction of the turbocharger TC. A bearing is arranged in the bearing hole 3b. A shaft 13 is inserted through the bearing. The bearing axially supports the shaft 13 in a rotatable manner. The bearing is a slide bearing. However, the present disclosure is not limited thereto, and the bearing may be a rolling bearing. A turbine impeller 15 is provided at a left end portion of the shaft 13. The turbine impeller 15 is accommodated in the turbine housing 5 so as to be rotatable. A compressor impeller 17 is provided at a right end portion of the shaft 13. The compressor impeller 17 is accommodated in the compressor housing 7 so as to be rotatable.

An intake port 19 is formed in the compressor housing 7. The intake port 19 is opened on the right side of the turbocharger TC. The intake port 19 is connected to an air cleaner (not shown). A diffuser flow passage 21 is defined by opposed surfaces of the bearing housing 3 and the compressor housing 7. The diffuser flow passage 21 increases pressure of air. The diffuser flow passage 21 has an annular shape. The diffuser flow passage 21 communicates with the intake port 19 on a radially inner side through intermediation of the compressor impeller 17.

A compressor scroll flow passage 23 is formed in the compressor housing 7. The compressor scroll flow passage 23 has an annular shape. The compressor scroll flow passage 23 is located, for example, on an outer side with respect to the diffuser flow passage 21 in a radial direction of the shaft 13. The compressor scroll flow passage 23 communicates with an intake port of an engine (not shown) and the diffuser flow passage 21. When the compressor impeller 17 rotates, the air is sucked from the intake port 19 into the compressor housing 7. The sucked air is pressurized and accelerated in the course of flowing through blades of the compressor impeller 17. The air having been pressurized and accelerated is increased in pressure in the diffuser flow passage 21 and the compressor scroll flow passage 23. The air having been increased in pressure is guided to the intake port of the engine.

An exhaust-air discharge port 25 is formed in the turbine housing 5. The exhaust-air discharge port 25 is opened on the left side of the turbocharger TC. The exhaust-air discharge port 25 is connected to an exhaust-gas purification device (not shown). In the turbine housing 5, a discharge flow passage 27, an accommodating space 29, and an exhaust flow passage 31 are formed. The discharge flow passage 27 allows communication between the accommodating space 29 and the exhaust-air discharge port 25. The discharge flow passage 27 is continuous with the accommodating space 29 in a rotation axis direction of the turbine impeller 15. The accommodating space 29 accommodates the turbine impeller 15. The exhaust flow passage 31 is formed on a radially outer side with respect to the turbine impeller 15. The exhaust flow passage 31 has an annular shape. The exhaust flow passage 31 includes a turbine scroll flow passage 31a. The turbine scroll flow passage 31a is arranged on a radially outer side with respect to the turbine impeller 15. The turbine scroll flow passage 31a communicates with the accommodating space 29 through intermediation of a communicating flow passage 33. That is, the communicating flow passage 33 allows communication between the turbine scroll flow passage 31a and the accommodating space 29. The communicating flow passage 33 is arranged on the radially outer side with respect to the turbine impeller 15.

The exhaust flow passage 31 communicates with an exhaust manifold of an engine (not shown). Exhaust gas exhausted from the exhaust manifold of the engine (not shown) is guided to the discharge flow passage 27 through the communicating flow passage 33 and the accommodating space 29. The exhaust gas guided to the discharge flow passage 27 rotates the turbine impeller 15 in the course of flowing.

A rotational force of the turbine impeller 15 is transmitted to the compressor impeller 17 through the shaft 13. When the compressor impeller 17 rotates, the pressure of the air is increased as described above. In such a manner, the air is guided to the intake port of the engine.

A vane member 35 is provided in the communicating flow passage 33. The vane member 35 is provided in order to adjust a flow rate of exhaust gas flowing into the accommodating space 29 of the turbine impeller 15. The vane member 35 has a substantially circular annular shape. The vane member 35 is arranged coaxially with the turbine impeller 15. The vane member 35 is arranged so as to cover an outer peripheral portion of the turbine impeller 15 over an entire periphery thereof.

The vane member 35 includes a base portion 35a and a plurality of vane portions 35b. The base portion 35a has a circular annular flat plate shape. The base portion 35a is arranged coaxially with the turbine impeller 15. The vane portions 35b are mounted to a surface on one side (in the example of FIG. 1, a surface on the right side) of the base portion 35a. The vane portions 35b are fixed to the base portion 35a. That is, in the vane member 35, the vane portions 35b are of a fixed type. The base portion 35a and the vane portions 35b may be a single member formed through integral molding, or may be separate members.

The plurality of vane portions 35b are arranged at intervals in a circumferential direction of the turbine impeller 15. For example, the plurality of vane portions 35b are arranged at equal intervals in the circumferential direction of the turbine impeller 15. Each vane portion 35b extends from the base portion 35a in a rotation axis direction of the turbine impeller 15. Each vane portion 35b is inclined with respect to the circumferential direction of the turbine impeller 15.

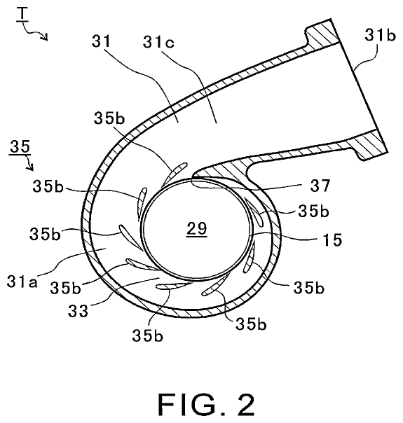

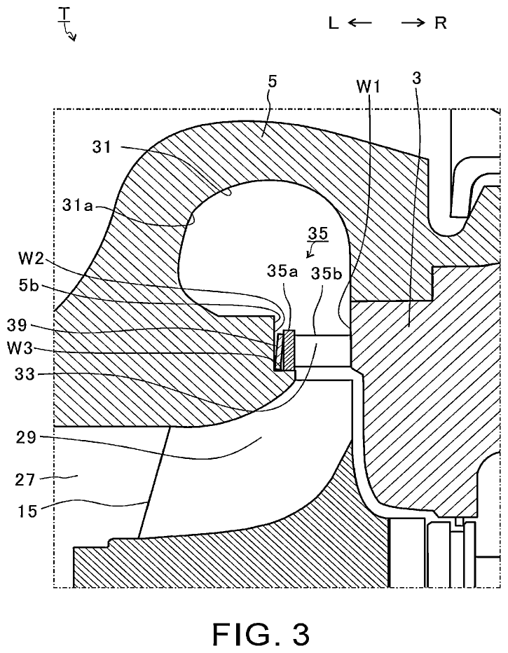

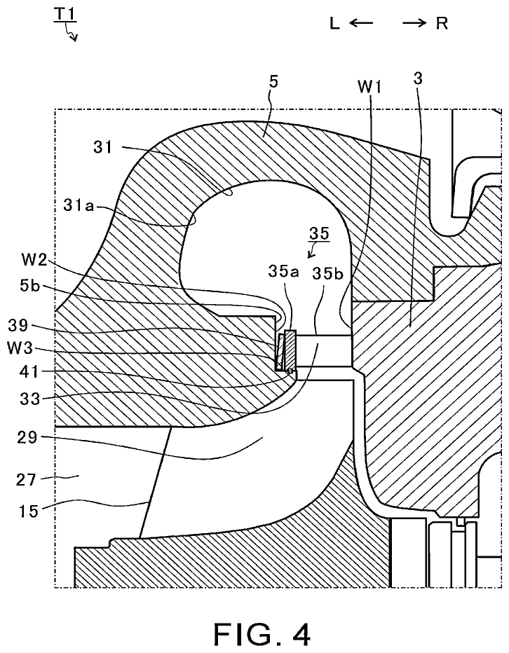

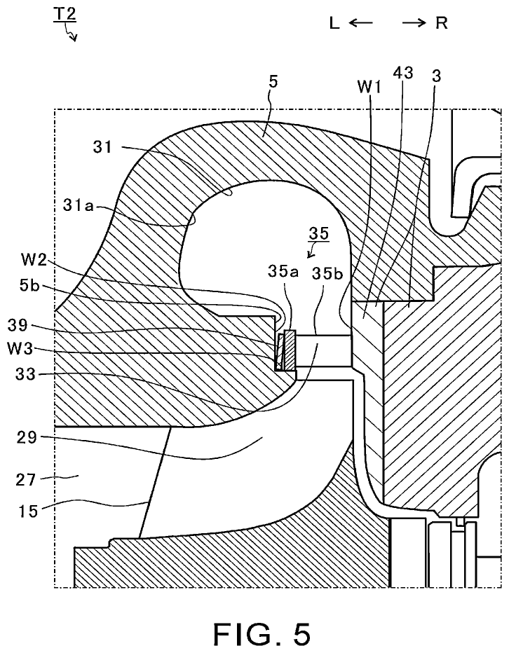

FIG. 2 is a sectional view taken along the line A-A in FIG. 1. In FIG. 2, regarding the turbine impeller 15, only an outer periphery of the turbine impeller 15 is indicated by a circle. As illustrated in FIG. 2, on a radially outer side of the accommodating space 29 (that is, a radially outer side of the turbine impeller 15), the exhaust flow passage 31 is formed. The exhaust flow passage 31 includes the turbine scroll flow passage 31a, an exhaust-air introduction port 31b, and an exhaust-air introduction passage 31c. The exhaust flow passage 31 allows communication between the accommodating space 29 and the exhaust-air introduction port 31b.

The turbine scroll flow passage 31a is formed into an annular shape over an entire periphery of the accommodating space 29. A tongue portion 37 is formed in the turbine housing 5. The tongue portion 37 is formed on an end portion of the turbine scroll flow passage 31a on a downstream side, and partitions the turbine scroll flow passage 31a into a downstream portion and an upstream portion of the turbine scroll flow passage 31a.

The exhaust-air introduction port 31b is opened to the outside of the turbine housing 5. The exhaust gas exhausted from the exhaust manifold of the engine (not shown) is introduced into the exhaust-air introduction port 31b. The exhaust-air introduction passage 31c is formed between the exhaust-air introduction port 31b and the turbine scroll flow passage 31a. The exhaust-air introduction passage 31c connects the exhaust-air introduction port 31b and the turbine scroll flow passage 31a to each other. The exhaust-air introduction passage 31c is formed, for example, into a straight shape. The exhaust-air introduction passage 31c guides the exhaust gas introduced from the exhaust-air introduction port 31b to the turbine scroll flow passage 31a. The turbine scroll flow passage 31a guides the exhaust gas introduced from the exhaust-air introduction passage 31c to the accommodating space 29 through the communicating flow passage 33. The communicating flow passage 33 is formed over the entire periphery of the accommodating space 29. In the communicating flow passage 33, the plurality of vane portions 35b of the vane member 35 are arranged at intervals in the circumferential direction of the turbine impeller 15. The exhaust gas sent from the turbine scroll flow passage 31a to the communicating flow passage 33 passes between the vane portions 35b, and then flows into the accommodating space 29.

In the turbine T including the vane member 35 in which the vane portions 35b are of a fixed type, when each member of the turbine T is thermally deformed, a clearance may be generated between the vane portions 35b and an inner wall portion of the housing of the turbine T. As a result, the flow of the exhaust gas flowing into the accommodating space 29 of the turbine impeller 15 may be disturbed, and hence there is a fear in that the efficiency of the turbine T may be decreased.

In the turbine T according to this embodiment, in order to suppress a decrease in efficiency of the turbine T, a method of mounting the vane member 35 to the housing of the turbine T is devised. In the following, with reference to FIG. 3 to FIG. 5, a configuration of a periphery of the vane member 35 is described in detail.

FIG. 3 is a partially enlarged view for illustrating the turbine T of the embodiment of the present disclosure. FIG. 3 is a partially enlarged view of a region indicated by the one-dotted chain line in FIG. 1. As illustrated in FIG. 3, the vane member 35 is arranged between a first inner wall portion W1 and a second inner wall portion W2 of the housing of the turbine T.

The first inner wall portion W1 is an inner wall portion that faces the communicating flow passage 33 from a side opposite to the discharge flow passage 27 (in the example of FIG. 3, the right side) in the housing of the turbine T. In the example of FIG. 3, a left wall portion of the bearing housing 3 corresponds to the first inner wall portion W1. In this manner, the first inner wall portion W1 is formed on, for example, the bearing housing 3.

The second inner wall portion W2 is an inner wall portion that faces the communicating flow passage 33 from the discharge flow passage 27 side (in the example of FIG. 3, the left side) in the housing of the turbine T. In the example of FIG. 3, a groove portion 5b is formed at a portion of the turbine housing 5 that is opposed to the first inner wall portion W1. The groove portion 5b is continuous with the turbine scroll flow passage 31a. The groove portion 5b extends from the turbine scroll flow passage 31a toward the turbine impeller 15 in a radial direction of the turbine impeller 15. The groove portion 5b has a circular annular shape. The groove portion 5b is arranged coaxially with the turbine impeller 15. A bottom surface portion of the groove portion 5b corresponds to the second inner wall portion W2. The bottom surface portion of the groove portion 5b is a circular annular portion that extends on a plane orthogonal to the rotation axis direction of the turbine impeller 15 to face the right side, in the groove portion 5b. In this manner, the second inner wall portion W2 is formed in, for example, the turbine housing 5.

The vane portions 35b of the vane member 35 are opposed to the first inner wall portion W1. Specifically, right end surfaces of the vane portions 35b are opposed to the first inner wall portion W1 in the rotation axis direction of the turbine impeller 15. The base portion 35a of the vane member 35 is fitted to a cylindrical wall portion W3 of the groove portion 5b. The cylindrical wall portion W3 of the groove portion 5b is a portion having a cylindrical shape extending in the rotation axis direction of the turbine impeller 15, in the groove portion 5b. Specifically, the base portion 35a is arranged on the radially outer side with respect to the cylindrical wall portion W3 of the groove portion 5b so as to cover the cylindrical wall portion W3 over an entire periphery thereof. An inner peripheral portion of the base portion 35a is fitted to the cylindrical wall portion W3.

In the turbine T, an elastic member 39 is provided in order to press the vane portions 35b of the vane member 35 against the inner wall portion of the housing of the turbine T. In the example of FIG. 3, the elastic member 39 is a disc spring. However, as described later, the elastic member 39 is not limited to the disc spring. The elastic member 39 has a circular annular shape. Specifically, the elastic member 39 is inclined to the right side toward the radially outer side.

The elastic member 39 is arranged between the second inner wall portion W2 and the vane member 35, and is sandwiched by the second inner wall portion W2 and the vane member 35 in the rotation axis direction of the turbine impeller 15. Specifically, the elastic member 39 is sandwiched by the second inner wall portion W2 and a left end surface of the base portion 35a. The elastic member 39 is in a state of being compressed in the rotation axis direction of the turbine impeller 15. Thus, a restoring force in the rotation axis direction of the turbine impeller 15 acts on a member held in abutment against the elastic member 39. A left portion of an inner peripheral portion of the elastic member 39 is held in abutment against the second inner wall portion W2. A right portion of an outer peripheral portion of the elastic member 39 is held in abutment against the base portion 35a. Thus, a restoring force of the elastic member 39 acts on the vane member 35 in the right direction. In this manner, the vane member 35 is biased by the elastic member 39 in the right direction, and thus the right end surfaces of the vane portions 35b of the vane member 35 are pressed against the first inner wall portion W1.

As described above, each member of the turbine T may be thermally deformed. For example, when the bearing housing 3 and the vane member 35 are each thermally deformed, in some cases, the contact state between the right end surfaces of the vane portions 35b and the first inner wall portion W1 is not in surface contact, but in line contact or point contact. In this case, a clearance is generated between the vane portions 35b and the first inner wall portion W1, and the flow of the exhaust gas flowing into the accommodating space 29 of the turbine impeller 15 from the communicating flow passage 33 is disturbed on a compressor side (right side in FIG. 3).

Meanwhile, unlike this embodiment, there is considered a case in which the vane portions 35b are biased in the left direction and are pressed against the inner wall portion facing the communicating flow passage 33 from the discharge flow passage 27 side (in the example of FIG. 3, the left side) in the housing of the turbine T. In this case, the vane portions 35b are arranged on the left side of the base portion 35a, and the left end surfaces of the vane portions 35b are pressed against the inner wall portion of the housing. In this case, when each member of the turbine T is thermally deformed to generate a clearance between the vane portions 35b and the housing, the flow of the exhaust gas flowing into the accommodating space 29 of the turbine impeller 15 from the communicating flow passage 33 is disturbed on the shroud side (left side in FIG. 3) that is a side opposite to the compressor.

The flow on the shroud side in the flow of the exhaust gas flowing into the accommodating space 29 from the communicating flow passage 33 is more liable to affect the efficiency of the turbine T as compared to the flow on the compressor side. When the flow on the shroud side is disturbed in the flow of the exhaust gas flowing into the accommodating space 29 from the communicating flow passage 33, the efficiency of the turbine T greatly decreases. Meanwhile, even when the flow on the compressor side is disturbed in the flow of the exhaust gas flowing into the accommodating space 29 from the communicating flow passage 33, the degree of the decrease in efficiency of the turbine T is small. As described above, in the turbine T of this embodiment, in a case in which each member of the turbine T is thermally deformed to generate a clearance between the vane portions 35b and the housing, a position at which the flow of the exhaust gas flowing into the accommodating space 29 of the turbine impeller 15 from the communicating flow passage 33 is disturbed is located on the compressor side. Thus, the decrease in efficiency of the turbine T can be suppressed.

The bearing housing 3 is less liable to be higher in temperature than the turbine housing 5. Thus, the thermal deformation amount of the bearing housing 3 is smaller than the thermal deformation amount of the turbine housing 5. Accordingly, the clearance generated between the vane portions 35b and the bearing housing 3 in the turbine T is smaller than the clearance generated between the vane portions 35b and the turbine housing 5 in the turbine in which the vane portions 35b are pressed against the turbine housing 5 unlike this embodiment. Thus, in the turbine T of this embodiment, the degree of disturbance of the flow of the exhaust gas due to the clearance generated between the vane portions 35b and the housing can be reduced. This also contributes to suppression of the decrease in efficiency of the turbine T.

As described above, in the turbine T, the plurality of vane portions 35b of the vane member 35 are opposed to the first inner wall portion W1 facing the communicating flow passage 33 from the side opposite to the discharge flow passage 27 (right side in the example of FIG. 3). The elastic member 39 is sandwiched by the second inner wall portion W2 facing the communicating flow passage 33 and the vane member 35 from the discharge flow passage 27 side (in the example of FIG. 3, the left side). With this, each member of the turbine T is thermally deformed so that the position of the clearance generated between the vane portions 35b and the housing is located in the vicinity of the first inner wall portion W1. Thus, the position at which the flow of the exhaust gas flowing into the accommodating space 29 of the turbine impeller 15 from the communicating flow passage 33 is disturbed due to the clearance is located on the compressor side. Accordingly, the decrease in efficiency of the turbine T can be suppressed.

In particular, in the turbine T, the elastic member 39 is a disc spring. With this, the elastic member 39 and the base portion 35a of the vane member 35 are held in abutment against each other over an entire periphery of the turbine impeller 15 in the circumferential direction. For example, in the example of FIG. 3, the right portion of the outer peripheral portion of the elastic member 39 has a circular shape, and is arranged coaxially with the turbine impeller 15. The entire range of such a portion of the elastic member 39 is held in abutment against the base portion 35a. Thus, a portion between the elastic member 39 and the base portion 35a is sealed to some extent. That is, leakage of the exhaust gas from the portion between the elastic member 39 and the base portion 35a to the accommodating space 29 side is suppressed to some extent. Accordingly, an unintended flow of the exhaust gas passing on the shroud side (left side in FIG. 3) with respect to the base portion 35a to flow into the accommodating space 29 from the communicating flow passage 33 is suppressed. Thus, the decrease in efficiency of the turbine T can be more effectively suppressed.

FIG. 4 is a partially enlarged view for illustrating a turbine T1 of a first modification example. The turbine T1 of the first modification example is different from the turbine T described above in that a seal member 41 is added. The seal member 41 is provided so as to seal a part between the base portion 35a of the vane member 35 and a housing of the turbine T1. That is, the seal member 41 is provided so as to suppress leakage of the exhaust gas from the part between the base portion 35a and the housing of the turbine T1 to the accommodating space 29 side.

The seal member 41 is provided between the base portion 35a of the vane member 35 and the housing of the turbine T1. In the example of FIG. 4, the seal member 41 is provided between the inner peripheral portion of the base portion 35a and the cylindrical wall portion W3 of the groove portion 5b of the turbine housing 5. The seal member 41 has a circular annular shape, and is arranged coaxially with the turbine impeller 15. For example, the seal member 41 is clamped by an annular groove formed in the inner peripheral portion of the base portion 35a over an entire periphery thereof and an annular groove formed in the cylindrical wall portion W3 over an entire periphery thereof. A cross-sectional shape of the seal member 41 may be a rectangular shape as in the example of FIG. 4 or may be a shape other than the rectangular shape (for example, a circular shape).

The seal member 41 seals a part between the base portion 35a and the cylindrical wall portion W3. Thus, even when the exhaust gas leaks to some extent from the part between the elastic member 39 and the base portion 35a to the accommodating space 29 side, passage of the exhaust gas between the base portion 35a and the cylindrical wall portion W3 is suppressed. Accordingly, an unintended flow of the exhaust gas passing on the shroud side (left side in FIG. 3) with respect to the base portion 35a to flow into the accommodating space 29 from the communicating flow passage 33 is more effectively suppressed.

As described above, in the turbine T1, the seal member 41 is provided between the base portion 35a and the housing of the turbine T1. With this, an unintended flow of the exhaust gas passing on the shroud side (left side in FIG. 3) with respect to the base portion 35a to flow into the accommodating space 29 from the communicating flow passage 33 is more effectively suppressed. Thus, the decrease in efficiency of the turbine T1 can be more effectively suppressed.

In the above, the example in which the seal member 41 is provided between the inner peripheral portion of the base portion 35a and the cylindrical wall portion W3 of the groove portion 5b of the turbine housing 5 has been described. However, it suffices that the seal member 41 be provided between the base portion 35a and the housing of the turbine T1, and the present disclosure is not limited to the above example. For example, the seal member 41 may be provided between the left end surface of the base portion 35a and the cylindrical wall portion W3 of the groove portion 5b of the turbine housing 5. For example, the seal member 41 may be provided on an upstream side of the flow of the exhaust gas with respect to an abutment portion between the elastic member 39 and the base portion 35a.

FIG. 5 is a partially enlarged view for illustrating a turbine T2 of a second modification example. The turbine T2 of the second modification example is different from the above-mentioned turbine T in that a heat-shielding plate 43 is added. The heat-shielding plate 43 is provided in order to shield heat input from the turbine housing 5 and the inside thereof to the inside of the bearing housing 3.

The housing of the turbine T2 includes the heat-shielding plate 43. The heat-shielding plate 43 is arranged in a portion facing an internal space of the turbine housing 5 in the bearing housing 3. That is, the heat-shielding plate 43 corresponds to a left portion of the bearing housing 3. In the example of FIG. 5, the heat-shielding plate 43 extends in the radial direction from an inner peripheral portion to an outer peripheral portion of the bearing housing 3. However, the heat-shielding plate 43 may not extend to the inner peripheral portion of the bearing housing 3, and may not extend to the outer peripheral portion of the bearing housing 3.

The heat-shielding plate 43 is less liable to pass heat compared to a portion of the bearing housing 3 other than the heat-shielding plate 43. With this, heat input from the turbine housing 5 and the inside thereof to the inside of the bearing housing 3 is shielded so that the inside of the bearing housing 3 is protected from heat. In the example of FIG. 5, the left wall portion of the heat-shielding plate 43 corresponds to the first inner wall portion W1. In this manner, the first inner wall portion W1 is formed on the heat-shielding plate 43.

As described above, the turbine T2 includes the heat-shielding plate 43 including the first inner wall portion W1. With this, similarly to the above-mentioned turbine T, the inside of the bearing housing 3 can be protected from heat while suppressing the decrease in efficiency of the turbine T2.

In the turbine T2, similarly to the above-mentioned turbine T1, the seal member 41 may be added.

An embodiment of the present disclosure has been described above with reference to the attached drawings, but, needless to say, the present disclosure is not limited to the above-mentioned embodiment. It is apparent that those skilled in the art may arrive at various alternations and modifications within the scope of claims, and those examples are construed as naturally falling within the technical scope of the present disclosure.

In the above, the example in which the elastic member 39 is a disc spring has been described. However, the elastic member 39 is not limited to the disc spring. For example, the elastic member 39 may be a coil spring. For example, the elastic member 39 may be a metal gasket formed of a metal thin film.

In the above, an example in which each of the turbines T, T1, and T2 is of a single scroll type (type in which the number of the turbine scroll flow passage 31a is one) has been described, but the type of each of the turbines T, T1, and T2 is not limited to the above-mentioned example. For example, each of the turbines T, T1, and T2 may be of a double scroll type (type in which two turbine scroll flow passages 31a are connected to the accommodating space 29 at different positions in the circumferential direction), or may be of a twin scroll type (type in which two turbine scroll flow passages 31a are arranged side by side in the rotation axis direction of the turbine impeller 15).

In the above, an example in which each of the turbines T, T1, and T2 is provided in the turbocharger TC has been described. However, each of the turbines T, T1, and T2 may be provided in other devices other than the turbocharger TC.

1. A turbine, comprising:
a housing including:
an accommodating space that accommodates a turbine impeller;
a turbine scroll flow passage arranged on a radially outer side with respect to the turbine impeller;
a communicating flow passage that allows communication between the turbine scroll flow passage and the accommodating space; and
a discharge flow passage continuous with the accommodating space in a rotation axis direction of the turbine impeller;
a vane member that includes a plurality of vane portions opposed to a first inner wall portion facing the communicating flow passage from a side opposite to the discharge flow passage, and is provided in the communicating flow passage; and
an elastic member sandwiched by a second inner wall portion facing the communicating flow passage from the discharge flow passage side, and the vane member.

2. The turbine according to claim 1,
wherein the vane member includes a base portion held in abutment against the elastic member, and
wherein a seal member is provided between the base portion and the housing.

3. The turbine according to claim 1, further comprising a heat-shielding plate including the first inner wall portion.

4. The turbine according to claim 1, wherein the elastic member is a disc spring.

5. A turbocharger, comprising the turbine of claim 1.

6. A turbocharger, comprising the turbine of claim 2.

7. A turbocharger, comprising the turbine of claim 3.

8. A turbocharger, comprising the turbine of claim 4.
